(19) United States
(12) Patent Application Publication
(10) Pub. No.: US 2022/0148030 A1
(43) Pub. Date: May 12, 2022

(54) SYSTEMS AND METHODS FOR PERFORMING USER-CUSTOMIZED ACTIONS ON AGGREGATED DATA

(71) Applicant: PMG Worldwide, LLC, FORT WORTH, TX (US)

(72) Inventors: GJORGI POPSTEFANOV, SOUTHLAKE, TX (US); CHRISTOPHER ALVARES, ARLINGTON, TX (US); CHRISTOPHER DAVIS, MINNEAPOLIS, MN (US); EMILY FOX, FORT WORTH, TX (US)

(21) Appl. No.: 17/303,378

(22) Filed: May 27, 2021

Related U.S. Application Data
(60) Provisional application No. 62/704,861, filed on May 31, 2020.

(51) Int. Cl. G06Q 30/02

(52) U.S. Cl. CPC G06Q 30/0244; G06Q 30/0243; G06Q 30/0276

(57) ABSTRACT

A digital platform for aggregating ad campaign data relating to one or more ad campaigns that is configured to allow users to generate customized data sets and perform user-customized operations on those data sets. The platform enables users to create and perform these operations on data from various sources through use of standardized data formats that is applied to the data retrieved from such sources.

### CITATION TO PRIOR APPLICATIONS

The present application claims priority to U.S. Provisional Application No. 62/704,861, titled “SYSTEMS AND METHODS FOR PERFORMING USER-CUSTOMIZED ACTIONS ON AGGREGATED DATA” and filed May 31, 2020.

### FIELD OF THE DISCLOSURE

The present disclosure relates generally to systems and methods for streamlining ad campaign-related, user decision making based on aggregated ad campaign data.

### BACKGROUND OF THE INVENTION

As electronic commerce continues to grow, so do the volumes of data relating to such commerce. Numerous platforms exist to keep track of this data which is often generated through monitoring site traffic, individual user preferences, market trends, online transactions, and other digital activity. Consumers and businesses with an online presence often rely on, or are otherwise influenced by, this data with respect to making various financial decisions.

Many digital media platforms and online storefronts utilize collected, consumer-specific data to support algorithms that customize consumer experiences. In the context of advertising, and from the consumer perspective, such algorithms may result in the consumer being served advertisements that are more aligned with that consumer's particular interests than the advertisements that would be served in the absence of the algorithms.

From the business perspective, aggregated data relating to consumer interactions with a business's products, services, and ad campaigns provides important insight into the relative success or value of such products, services, and ad campaigns. Looking again to advertising specifically, businesses that rely on third-party online platforms (such as Amazon and YouTube) to serve ads must, as with more traditional media, purchase ad space. In many cases, ad campaigns run online involve the purchase of ad space across many platforms to maximize exposure and generate traffic related to those products and/or services being promoted.

Decisions regarding whether to continue an ad campaign, or even to modify a campaign's parameters, are driven by consumer data. At present, much of this data is collected by third party systems like Google Ads. While businesses may have access to this data, there exists a need to facilitate its aggregation, review, and processing. Present solutions may gather data from certain sources to allow a business user to view said data, but the process is cumbersome and generally results in the presentation of raw data that must then be parsed through and interpreted by the user.

Furthermore, existing data aggregation platforms and solutions offer no ability to act directly on this data once reviewed. In the case of managing ad campaigns, business users must navigate to each third-party advertising platform to modify any relevant campaign parameters based on the raw data provided by present solutions. Accordingly, there is a need for an improved solution that collects, presents, and allows direct action upon data for business users.

### SUMMARY OF THE INVENTION

In view of the foregoing, it would well-serve business users in the e-commerce space to provide a platform for aggregating, analyzing, and acting upon ad campaign-related data. Were such a platform available, businesses engaging in online promotional campaigns would benefit from their enhanced ability to generate actionable data sets from third-party sources.

The present disclosure includes various illustrative embodiments of a platform for allowing users to access, and execute customized program logic against, at least one aggregated data set generated from user-specified sources. Such sources may have data entries corresponding to user-specified requirements in order to cause some action to be performed on, or related to, a communicably coupled user-specified platform.

### BRIEF DESCRIPTION OF THE DRAWINGS

FIG. 1 depicts an interface element through which users may prompt credential retrieval in accordance to certain embodiments of the present disclosure.

FIG. 2 depicts an interface element for configuring data source information in accordance to certain embodiments of the present disclosure.

FIG. 3 depicts an interface element for selecting dimensions and metrics in accordance to certain embodiments of the present disclosure.

FIG. 4 depicts an interface element for selecting a backfill time period in accordance to certain embodiments of the present disclosure.

FIG. 5 depicts an interface element for creating an ad campaign data table in accordance to certain embodiments of the present disclosure.

FIG. 6 depicts an interface element for causing an action to be performed in accordance to certain embodiments of the present disclosure.

FIG. 7 depicts an interface element for customizing an action in accordance to certain embodiments of the present disclosure.

FIG. 8 depicts an interface element for configuring action parameters in accordance to certain embodiments of the present disclosure.

FIG. 9 depicts an interface element for scheduling performance of an action in accordance to certain embodiments of the present disclosure.

FIG. 10 depicts an interface element for reviewing an action's configuration in accordance to certain embodiments of the present disclosure.

FIG. 11 depicts an interface element corresponding to an audit of an action's performance in accordance to certain embodiments of the present disclosure.

FIG. 12 depicts an interface element for creating a new action type in accordance to certain embodiments of the present disclosure.

FIG. 13 depicts an interface element for configuring a new action type in accordance to certain embodiments of the present disclosure.

FIG. 14 depicts an interface element for selecting an API service for a new action type in accordance to certain embodiments of the present disclosure.

FIG. 15 depicts an interface element for selecting the relevant fields to be modified by a new action type in accordance to certain embodiments of the present disclosure.

### DETAILED DESCRIPTION

The present disclosure relates to a platform for aggregating, reviewing, and taking action upon ad campaign data. It should be clear that the description is not intended to limit the invention to any specific embodiments as set forth herein and that those variations, changes, substitutions, or equivalent components apparent to those skilled in the art should not be considered significant differences from the intended scope of the invention.

An illustrative embodiment of the platform includes a data aggregation module and an action customization module. It would be understood by those of ordinary skill in the art that these modules may be embodied in numerous ways including as discrete bodies of executable code or various sections of one body of executable code. For purposes of this disclosure, these modules are described as executed programming. The data aggregation module is configured to communicate with at least a first data source through a first data source application programming interface (“API”) according to methods known in the art. The action customization module is configured to allow a user to specify an action to take based on a generated data set. The action customization module is operably coupled to the data aggregation module.

The platform may take the form of a web-based interface, such as a website, through which the user is allowed access to modules described herein. The user's identity may require authentication in any manner including those conventionally known in the art.

The user may provide to the platform information or details relating to at least one ad campaign which the platform then stores in memory (local or remote). This information relating to at least one ad campaign may include a campaign identifier (an identification number or other designator) used to identify the at least one ad campaign from any other ad campaigns the user may provide information about. Any such information may be used to facilitate displaying, or otherwise allowing the user to access, data corresponding to these ad campaigns through the interface.

The first data source may include any source of relevant data, such as Google Ads, for data pertaining to at least one ad campaign. The data aggregation module may be further configured to take data from the first data source and segment it into discrete fields defined by platform a power user.

With respect to a first data source providing a data object containing information relating to a particular ad campaign, the information may be separated into values for fields such “campaign_ID,” “CPC” (cost per click), “CTR” (click through rate), or any other fields for which values can be determined from the data object. The values may be stored in a platform database (or table). Of course, it would be well understood by a person of ordinary skill in the art that a first data source may provide numerous data objects for, or a single object containing information about, a plurality of ad campaigns.

Through the web-based interface, the user may instruct the platform to generate an ad campaign data table that is populated with data from a first table source as collected by the data aggregation module. The user is able to select a particular first table source from a list of available data sources which are determined initially by the platform developer. In certain embodiments, this list of available data sources may be updated to include additional data sources in any manner known to those of ordinary skill in the art.

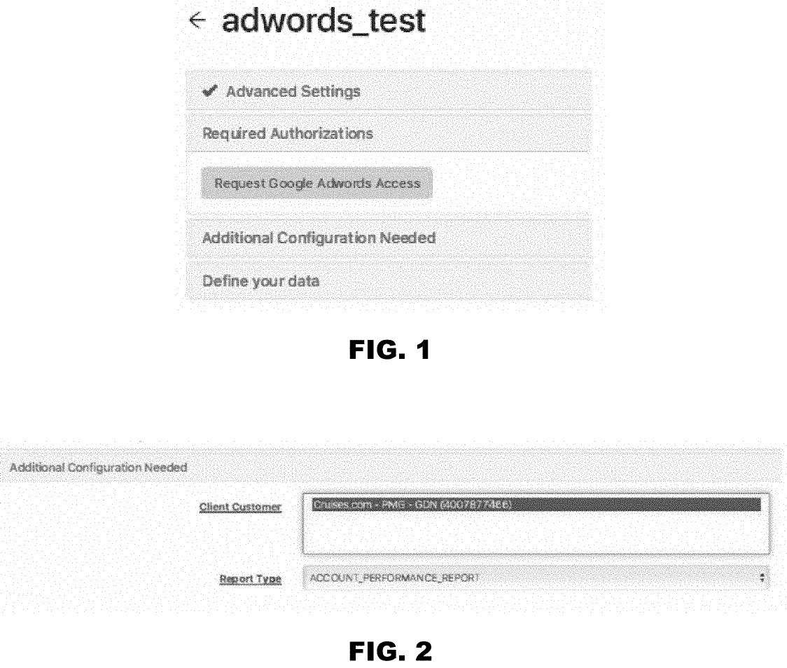

The first table source may be the first data source, such as Google Ads. When the user selects Google Ads, the user may also initiate an OAuth2.0 dance to retrieve credentials from each of the relevant API connections via a request button as shown in FIG. 1. The user may further be able to identify additional parameters as provided by the relevant API specification and that will be needed to utilize the first data source. An exemplary interface element for this parameter configuration is shown in FIG. 2.

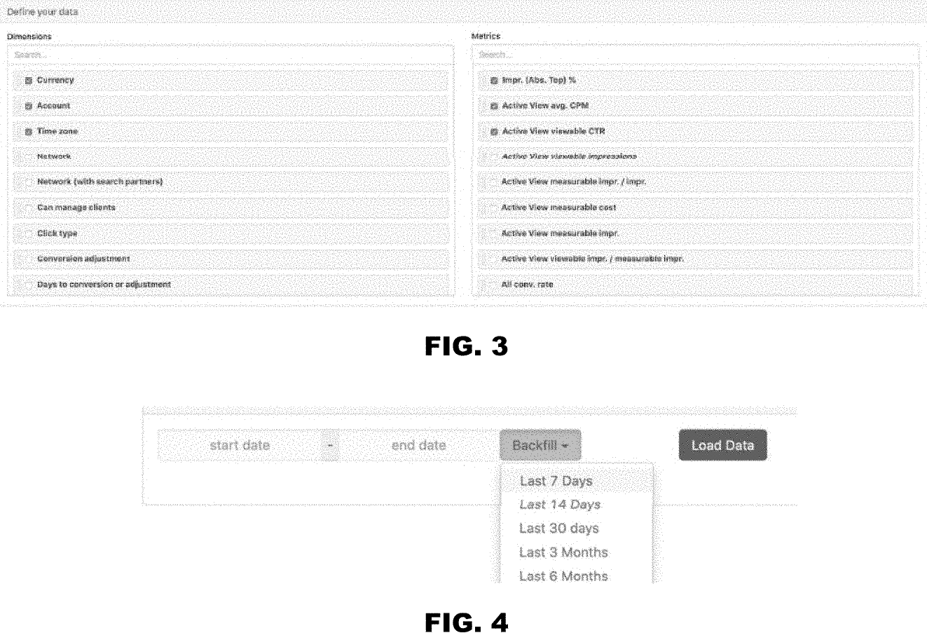

Additionally, the user is able to select which fields to populate with values of the first table source from a list of available fields. This list of available fields is derived from those fields made available by the data object(s) provided by the first table source. FIG. 3 provides an illustrative example of what the user may see when making this selection.

The user may also select a period of time to be reflected by values in the ad campaign data table. When utilizing a data source API connection, the data aggregation module may rely on ad account information, such as that provided by the user, to retrieve the requested data.

The user may select to “backfill” the ad campaign data table for a 7-day, 14-day, or other specified period. The user may select this period from a list of pre-defined periods or set a custom period. As shown in FIG. 4, this selection may be made via a menu presented to the user.

If set to a 7-day backfill, the data aggregation module will retrieve and enter the requested data for the preceding seven-day period into the ad campaign data table. When populating the table, the data aggregation module may start by retrieving data for that first day and build up to a full seven days' worth of data by pulling new updated data every day. Each day after completing the initial backfill, the data aggregation module may update the oldest ad campaign data table entry and enter new data corresponding to the new day. In doing this, the ad campaign data table maintains a moving data “window” for the user-selected period (7-day, 14-day, or custom). As indicated above, these ad campaign data table entries may include data for at least one ad campaign, and an ad campaign data table may additionally, or alternatively, include data corresponding to a plurality of ad campaigns.

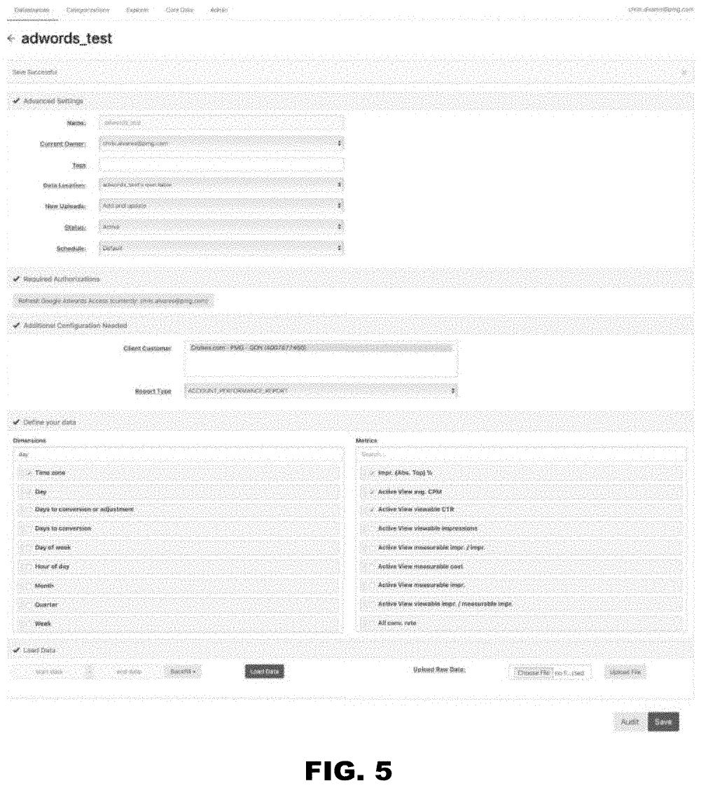

In some embodiments, the user may provide instructions relating to the generation of an ad campaign data table to the platform via an interface elements such as that shown in FIG. 5.

In other embodiments, a user can then create a second ad campaign data table using a second table source and use SQL to combine both the first and second ad campaign data tables to feed into the action customization module.

The user may also, through the interface, direct the action customization module to cause actions to be performed based on a data set generated as a result of customized logic being applied to the ad campaign data table. The user may select an action from a list of available, pre-defined actions or action types. These actions may be defined by the platform power users and include actions related to management of the ad campaign. For example, one action may be “Pause Campaign” wherein the platform, through an ad service API, instructs an independent ad platform to pause the serving of advertisements on that independent ad platform. The particular instruction sent to the independent ad platform via the ad service API will depend on the particular configuration of the ad platform and related API as would be understood by one of ordinary skill in the art. Continuing the example above, one embodiment of the action customization module is specifically configured by the platform developer to allow transmission of an instruction to “pause” an ad campaign that would be understood by the independent ad platform when received via the ad service API connection—such as an instruction to update a “status” field or variable stored locally on the independent ad platform from “active” to “paused.”

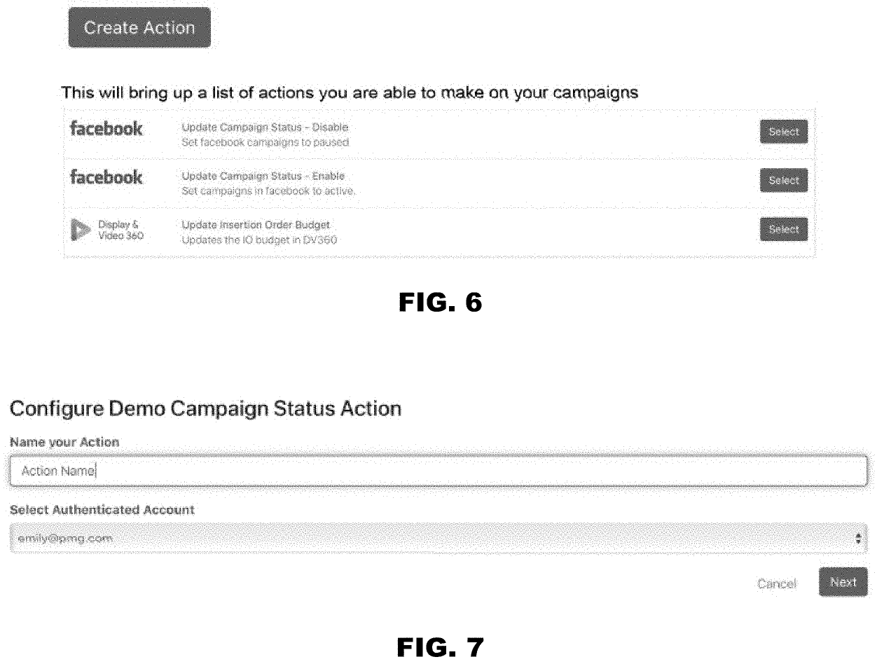

In some embodiments, the available actions may be presented to the user as shown in FIG. 6. Moreover, once an action is selected, the user may provide a custom name for the particular action and select an authenticated account to authorize the action as shown in FIG. 7.

When utilizing an ad service API connection, the action customization module may rely on ad campaign information, such as that provided by the user or that returned from the ad campaign data table, to perform the requested action. Additionally, the user may specify under what conditions the action customization module causes an action to be performed. In one embodiment, when selecting an action from the list of available, pre-defined actions, the user may schedule an action to run periodically. The action will only execute successfully if an action condition is satisfied.

This action condition may be input in the form of program logic such as an SQL statement. For example, the user may enter an SQL statement that returns all ad campaigns (such as in the form of a set of entries from the ad campaign data table) having a click-through rate or return on investment (“ROI”) below a certain threshold. Such an SQL statement may be input as follows in certain embodiments:
select campaign_id from client.adwords_test where date=CURRENT_DATE−1 and (revenue/spend)<1//find ROI less than one

These exemplary measures (CTR and ROI) may be included in a data object retrieved and parsed by the data aggregation module or may be generated from a data object according to calculations and methods conventionally known in the art. The SQL statement is run against the relevant ad campaign data table. The action will only execute if there are rows delivered after running the SQL statement.

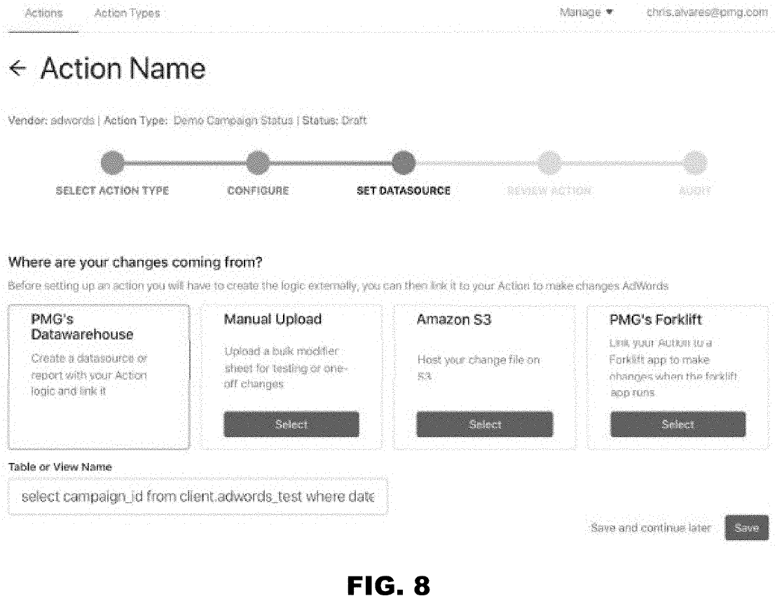

In certain embodiments, the user may be presented with an interface element like that shown in FIG. 8. Using this interface element, the user may select the location of the data to be queried and acted upon. The user may also enter the relevant SQL statement to be run against the data.

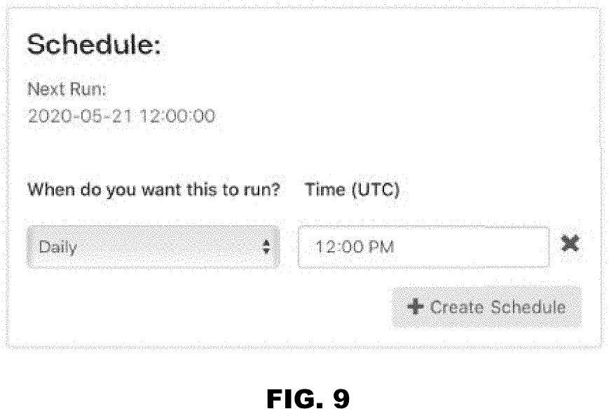

As mentioned above, the user may also specify that this action condition be checked periodically (hourly, daily, etc.). Once entered, the platform may be instructed to run the SQL statement every period. In certain embodiments, the user is presented with this ability through a menu such as that depicted in FIG. 9. For all table entries that are returned, if any, the user-specified action will be performed. Using the action and action condition examples above, all campaigns with a “campaign_ID” present in the returned, filtered results will be paused via command or instruction sent by the action customization module to the relevant independent ad platform(s) as specified by those results.

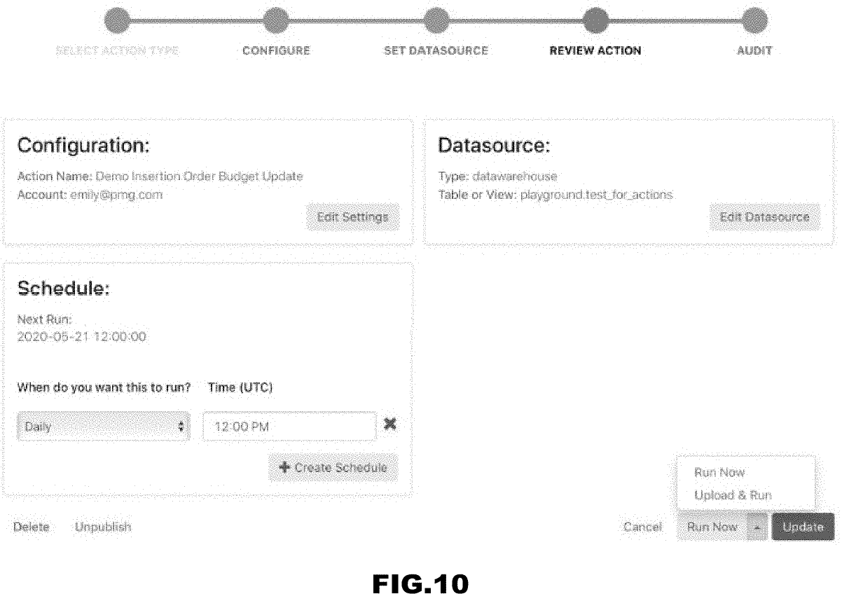

In some embodiments, before an action in performed, the user may be given the opportunity to review their selections via an interface element as shown in FIG. 10.

By having the data aggregation module update the ad campaign data table periodically and the action customization module check the action condition periodically, the platform enhances the user's ability to manage its ad campaigns by eliminating the need to review raw data before navigating to each ad service platform to perform the desired action. In further embodiments, the platform is configured to allow the user to view the ad campaign data table or the results of the most recent action condition check. In even further embodiments, the platform is configured to allow a user to manually trigger an action. The user may trigger an action to occur through any means including those conventionally known in the art, such as via an on-screen button corresponding to the action. Triggering an action will result in the action customization module causing that action to be performed (via command or instruction sent through an ad service API) for any specified ad campaign even if the ad campaign did not meet any previously specified action condition. Ad campaigns may be selected from a list of available ad campaigns when the user attempts to trigger an action. Commands or instructions may be sent when the action is performed to any independent ad platform(s) that associated with an ad campaign selected by the user wherein that association may be determined by ad campaign information entered by the user or information in the ad campaign data table.

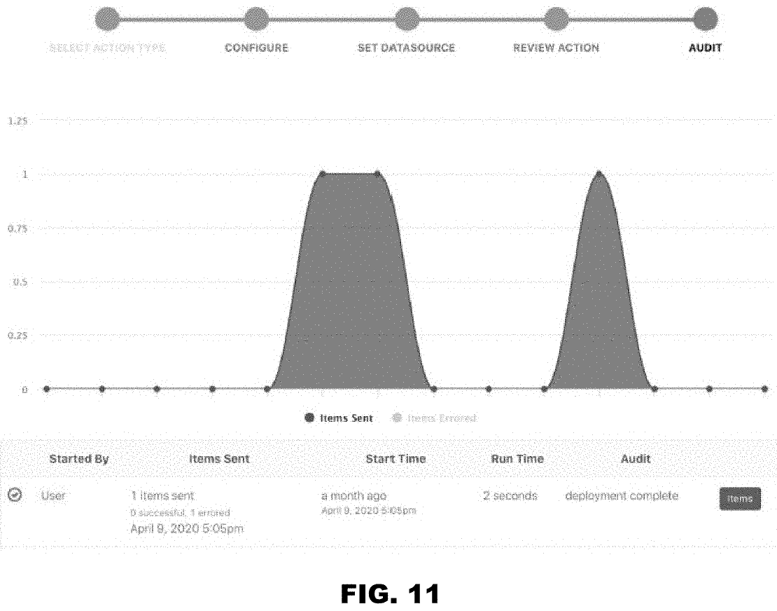

In some embodiments, after an action is performed, the user may be presented an audit page such as that shown in FIG. 11.

In certain embodiments, the platform may be updated by the platform developer to include additional data sources, data fields, and ad service platforms as needed to accommodate the evolving needs of the platform's users. As would be well understood by those of ordinary skill in the art, such updates may require integration of additional APIs to retrieve data and modification of various action definitions to utilize new ad service API connections. Moreover, as one of ordinary skill in the art would understand, for purposes of using data from the various sources across the platform generally or as more specifically set out above, some standardized data format or template (including comma-separated-value (“CSV”) files) may be developed and used on, or otherwise applied to, data retrieved from the various data sources.

In further embodiments, action types may also be added to the platform. In general, creating an action type will involve generating a script that can add, update, delete, or otherwise adjust/modify campaigns (or other platform data) with a standardized input in the form of a CSV output. The action type will be configured to pull in columns (data) necessary for manipulation, perform any required authentication for vendors/services, and to act on each row inside of a CSV file. Data may be pulled from a CSV file or other datastore (which is converted to a CSV file). Once added, the action type may be selected as described above when creating an action. The action type may then be set to run on a schedule to pull data from a CSV file and to pipe the data into the action type's script that automatically adds, updates, deletes, or otherwise adjusts/modifies the relevant campaigns while ensuring input from the CSV file is the same as the inputs designated within the action type.

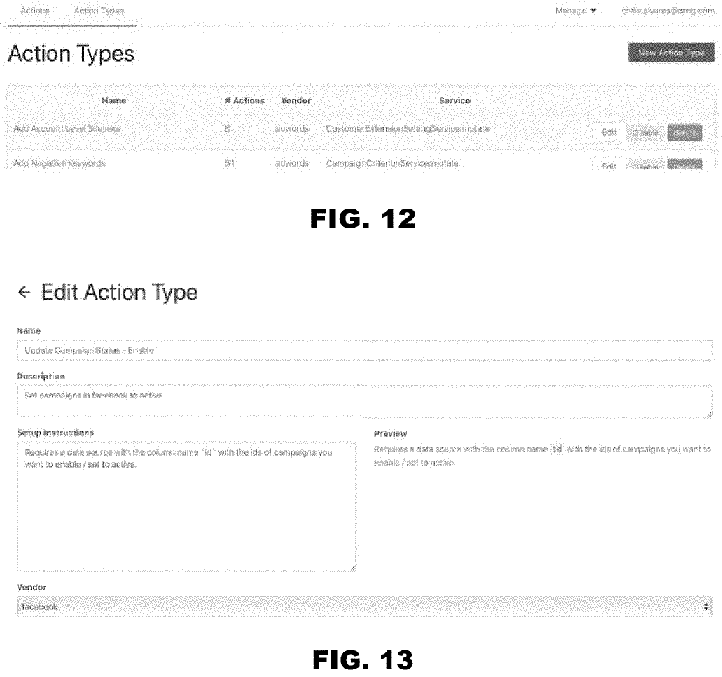

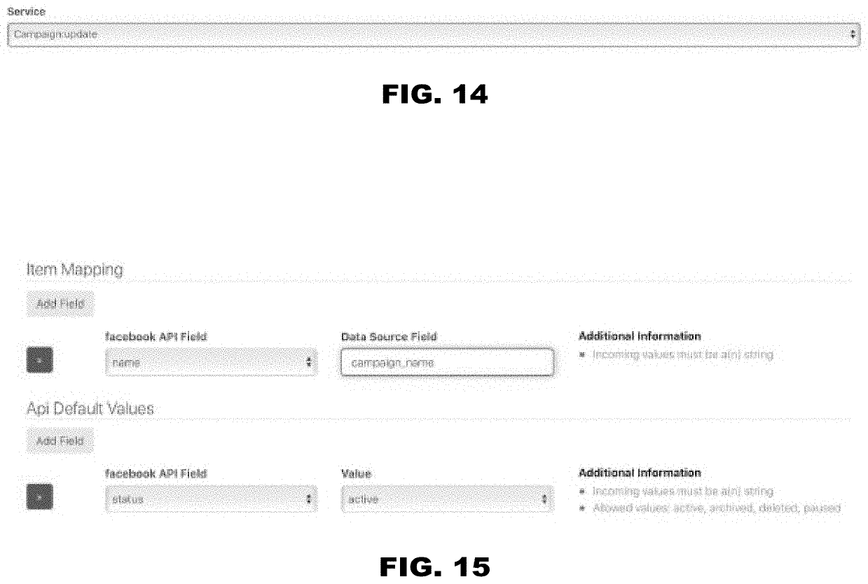

In some embodiments, action type creation may be accomplished via an interface element such as that shown in FIG. 12. Action types may be configured through an interface element such as that shown in FIG. 13. An API service may be selected from a dropdown as shown in FIG. 14. This service will determine if a campaign is to be added, removed, or updated. If a campaign is to be updated, any fields to be modified may be selected through an interface element as shown in FIG. 15. The “Data Source Field” will be either the header of the relevant CSV file or the SQL output from which the target data originates. Default values may be hard coded to be automatically applied. Once an action type is configured, it may be saved for later use when creating and performing actions as described above.

Any restrictive language used in conjunction with any embodiments as disclosed herein such as “must,” “requires,” “needed,” or the like should be taken as applying only to those specific embodiments and not to embodiments as disclosed generally.

As discussed previously, embodiments discussed herein can be implemented in suitable computer-executable instructions that may reside on a computer readable medium (e.g., a hard drive (HD)), hardware circuitry or the like, or any combination. Embodiments of a hardware architecture for implementing certain embodiments would be well understood by those of ordinary skill in the art. Certain embodiments can include one or more computers communicatively coupled to a network.

At least portions of the functionalities or processes described herein can be implemented in suitable computer-executable instructions. The computer-executable instructions may be stored as software code components or modules on one or more computer readable media (such as non-volatile memories, volatile memories, direct access storage drive (DASD) arrays, magnetic tapes, floppy diskettes, hard drives, optical storage devices, etc. or any other appropriate computer-readable medium or storage device). In one embodiment, the computer-executable instructions may include lines of compiled C++, Java, hypertext markup language (HTML), or any other programming or scripting code.

Additionally, the functions of the disclosed embodiments may be shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A digital platform for aggregating and analyzing data comprising:
a data aggregation module configured to communicate with at least a first data source and to generate an aggregated data set from said first data source, wherein said aggregated data set is generated based on at least one user-defined parameter;
an action customization module configured to perform a user-defined action based on said aggregated data.

2. The platform of claim 1 wherein said data aggregation module communicates with said first data source via an application programming interface (API).

3. The platform of claim 2 wherein said a first data source stores data relating to at least one ad campaign.

4. The platform of claim 3 wherein said at least one user-defined parameter is selected from a list of available data fields from said first data source, and wherein said user-defined parameter becomes an aggregated data set data field.

5. The platform of claim 4 wherein said data aggregation module may be instructed to populate said aggregated data set data field with a first set of retrieved data from said first data source over a user-specified period of time.

6. The platform of claim 5 wherein said user-defined action includes an action type, and wherein said action type is a pre-programmed function that can modify the status of said ad campaign.

7. The platform of claim 6 wherein said user-defined action includes an action condition, wherein said action type is only executed when said action condition is met.

8. The platform of claim 7 wherein said action condition may be provided by a user as a SQL statement to be run against said aggregated data set.

9. The platform of claim 8 wherein said action condition is checked periodically at a user-defined rate.

10. The platform of claim 9 wherein said user accesses said data aggregation module and said action customization modules through a program interface.

11. The platform of claim 10 wherein said program interface is web-based.
